(19) United States
(12) Patent Application Publication
(10) Pub. No.: US 2008/0041919 A1
(43) Pub. Date: Feb. 21, 2008

(54) Devices for manipulating a work piece in a welding system

(75) Inventor: George J. Daumeyer, Fishers, IN (US)

Correspondence Address: KRIEG DEVAULT LLP, ONE INDIANA SQUARE, SUITE 2800, INDIANAPOLIS, IN, 46204-2079, US

(73) Assignee: Athena Plus, Inc.

(21) Appl. No.: 11/504,125

(22) Filed: Aug. 15, 2006

(51) Int. Cl. B23K 37/00; B23K 35/38

(52) U.S. Cl. 228/47.1; 228/218

(57) ABSTRACT

A welding system includes a resistance type or other type welder with a support member and a tool for holding a work piece supported on the supported member. The support member and tool are configured to provide a substantially gaseous fluid bearing between the support member and the tooling to allow the tooling to be moved relative to the support member. When the bearing is not provided, the tooling is supported on the support member so that an electrical current pathway is provided between the tooling and the support member.

### BACKGROUND

Various devices have been employed in welding systems to move work pieces to allow welding operations to be performed at various locations on the work piece, or to sequentially position multiple work pieces in position for welding operations. For example, work pieces can be supported by tooling mounted on a work surface of a table. Rollers between the tooling and table allow the tooling and thus the work piece to move to different locations along the table. Other types of systems employ tables having rails along which the tooling supporting the work piece is slidably moved with rollers, ball bearings, or lubricants.

Certain types of welding systems, such as resistance welding systems, employ an electrical connection between the table and the tooling supporting the work piece to provide a path for high current electricity flow. Most resistance welding tooling is fixed in position and made of strong yet highly conductive special copper alloys. Some systems provide for shifting of tooling during welding operations that employ non-conductive components and use shunts or air-cooled or water cooled jumpers to electrically connect the tooling to provide an electricity flow path. Systems can also employ connection mechanisms that are provided by conductive components such as rollers and springs.

Prior systems that employ such connection mechanisms can be cumbersome and costly, limiting the desirability of resistance welding and usefulness in certain applications. Inefficiencies exist in connecting high amperage pathways between movable components. In addition, rollers and springs create friction and wear with use, which can result in the need for maintenance and replacement of the moving parts, adding further cost to such systems. Inefficiencies are also created by the change-over time required to change welding applications. Thus, there is a need for additional contributions in this area of technology.

### SUMMARY

One aspect of the present application is a welding system that includes a resistance type or other type welder with a support member and a tool for holding a work piece supported on the support member. The system is configured to provide a substantially gaseous fluid bearing between the support member and the tooling to allow the tooling to be moved relative to the support member without contacting the support member, reducing or eliminating friction during such movement. When the gaseous fluid bearing is not provided, the tooling re-engages the support member so that an electrical current pathway is provided between the tooling and the support member without the necessity of employing shunts, jumpers or conductive lubricants.

In a further aspect, a weld-through device for electrical welding systems includes a support member comprised of an electrically conductive material. The support member supports tooling on the support member in an engaged position with a support surface and a plurality of holes opening at the support surface. The holes are interconnected to permit passage of substantially gaseous fluid therethrough from a fluid supply to support the tooling in a gaseous fluid supported position relative to the support member for movement of the tooling relative to the support member.

In another form, a weld-through device for electrical welding systems includes a support member and tooling. The support member includes a support surface and is comprised of electrically conductive material. The tooling includes a base comprised of electrically conductive material supported on the support surface of the support member in an engaged position to provide an electrical path through the support member. There is further provided means for lifting the tooling from the engaged position to a spaced relationship with the support surface for re-positioning the tooling relative to the support surface in the spaced relationship.

In another aspect, a method for welding a workpiece comprises: securing a workpiece to tooling engaged to a support member; spacing the tooling from the support member along a support surface; moving the tooling relative to the support member with the tooling spaced from the support member; and re-engaging the tooling to the support member along the support surface to provide an electric current pathway between the tooling and the support member.

Further embodiments, forms, features, aspects, benefits, objects, and advantages of the present application shall become apparent from the detailed description and figures provided herewith.

### BRIEF DESCRIPTION OF THE DRAWINGS

FIG. 1 is a diagrammatic view of a welding system with a weld-through device and a gaseous fluid supply.

FIG. 2 is a sectional view of a portion of the support member and tooling of FIG. 1 in an engaged state.

FIG. 3 is a sectional view of the portion of the support member and tooling in FIG. 2 with the tooling in a gaseous fluid supported state.

FIG. 4 is an elevation view of one embodiment support member and tooling positioned relative to an electrode of a welding system.

FIG. 5 is a longitudinal section through the elevation of FIG. 4 looking the same direction as FIG. 4.

FIG. 6 is an enlarged plan view of the support member of FIG. 4.

FIG. 7 is a side elevation view of the support member of FIG. 4.

FIG. 8 is a diagram showing various movement patterns of the tooling relative to the support member.

FIG. 9 is a diagram of another embodiment support member.

### DETAILED DESCRIPTION OF SELECTED EMBODIMENTS

For the purpose of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates.

A support member for resistance and other type of welding systems is provided that includes a fluid delivery system to provide a gaseous fluid flow through the support member to support tooling above the table or other support member with a substantially gaseous fluid bearing. The support surface can include a plurality of holes arranged to support the tooling in a frictionless manner relative to the support member. The tooling can then be moved manually or automatically to reposition one or more work pieces relative to the support member for additional welding procedures by the welding system at other locations on the workpiece or on another workpiece. The support surface can be arranged as an upper surface of a support member with the plurality of holes oriented in the upper surface of the support member.

In alternative arrangement, the base of the tooling provides a support surface along its lower surface having a plurality of holes therein oriented toward the support member. The base is supported with a substantially gaseous fluid bearing delivered through the base to the support surface holes to separate the base from the support member.

The support surface can be in the form of a plate with a flat or a concave surface. Once supported by the gaseous fluid bearing, the tooling can be moved linearly relative to the support member or rotated relative to the support member. The support member and tooling can be comprised at least partially of highly conductive material so that when the fluid bearing is removed the tooling re-engages the support member and provides a conductive path to support additional welding operations. As used herein, the gaseous fluid includes air or any suitable gaseous element or combination of gaseous elements suitable for supplying a lifting force to the tooling.

In operation, the tooling and support member are positionable in an engaged state for welding where the support member and the adjacent surface of the tooling are in contact with one another to conduct the welding current. When gaseous fluid is introduced to the fluid delivery system of the support member or base with the support surface, the tooling base plate is separated from the support member in a substantially gaseous fluid supported state and floats or is elevated-above the support member for movement along or about the support member. Such movement in the fluid supported state can be conducted without the need for lubricants, wheels, or non-conductive sliding surfaces with current conductive lubricants. The fluid flow provides additional cooling and eliminates or reduces dust between the members. The tooling can be moved in the gaseous fluid supported state to another location. The gaseous fluid is turned off or diverted from the fluid delivery system so that the tooling re-engages the support member by gravity or by a seating mechanism. The welding process can then be repeated on the work piece or on another work piece supported by the tooling.

The support member can be made from copper alloy with a smooth finish on the support surface to allow conductivity of several thousand amps therethrough. The support surface can be planar, concave, or include multiple planar surfaces offset from one another to form plateaus and valleys. The tooling includes a base that also has a smooth finish of highly conductive material along the bottom surface or surfaces supported by the support member so that a sufficient electrical connection is provided therebetween when the tooling is engaged to the support member at the support surface. The holes in the support surface are sized and spaced to deliver gaseous fluid in sufficient pressure to support the weight of the tooling and work pieces relative to the support member, or to provide separation of the tooling and the support member. The support member can include guides in the form of pins, rollers and other structures to maintain and provide alignment of the tooling as it is moved on the support member and to limit such movement. Gaseous fluid can be delivered to one or more inlets from a fluid supply that includes a filter to filter the fluid and regulate it through an appropriate valve structure that is controlled manually or automatically.

Referring to FIG. 1, there is shown a welding system 10 with a frame 12 supported on ground or floor 14. Welding system 10 further includes an electrode 16 electrically coupled to a current source to provide electricity for welding operations. Welding system 10 further includes a weld-through device 20 that supports a work piece and permits welding of the work piece using electricity delivered through electrode 16. Weld-through device 20 is electrically coupled in welding system 10 to allow electricity to flow therethrough. It is contemplated that welding system 10 can be a resistance type welding system as shown. Furthermore, the present invention can have application in any other welding or fabrication system where movement of a work piece relative to the welding or fabrication system is desired.

Weld through device 20 includes tooling 22 and a support member 40 that supports tooling 22. Tooling 22 includes electrodes 26, 28 and work piece support 30 positioned on a base 24. A work piece can be coupled to support 30 and moved by moving tooling 22 on support member 40 so that electrode 16 can work in conjunction with electrodes 26, 28 to spot weld the work piece. Other arrangements are also contemplated, including arrangements where the electrodes are situated for seam welding and other welding techniques.

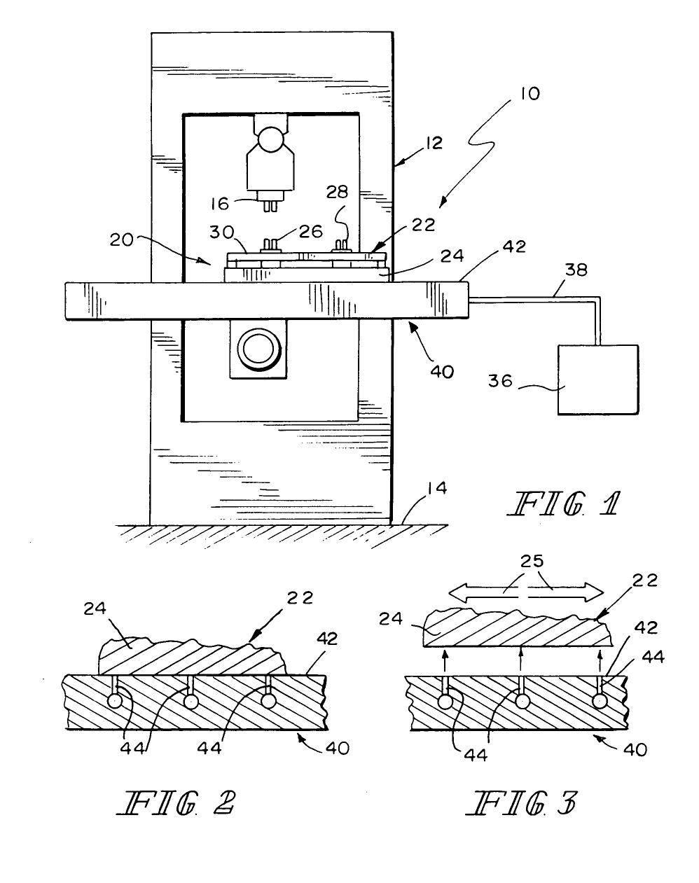

Support member 40 includes a support surface 42 and tooling 22 includes base 24 supported by support member 40 on support surface 42 in an engaged position, as shown in FIG. 2. Support member 40 is coupled to a fluid supply 36 with a connector 38. Connector 38 can comprise one or more hoses, tubes, lines or other connecting devices. Support member 40 includes a plurality of interconnected holes 44 in support surface 42 that deliver substantially gaseous fluid from fluid supply 36 to support surface 42, it being understood that only a few of the holes 44 are specifically identified by lead lines for purposes of clarity. The gaseous fluid is supplied so that the portion of holes 44 overlapped by base 24 provide sufficient pressure to lift base 24 and tooling 22 above support surface 42 of support member 40, as shown in FIG. 3, to provide a gaseous fluid bearing or cushion therebetween. In an alternative form, support surface 42 is provided along the bottom surface of base 24 with a plurality of interconnected holes to deliver air through base 24 to lift it above support member 40.

In the fluid supported state of FIG. 3, tooling 22 is moved relative to support member 40 along or about support surface 42 as indicated by arrow 25 to re-position the work piece. The gaseous fluid supply can then be terminated and the fluid pressure dissipates so that tooling base 24 re-engages support surface 42 as shown in FIG. 2 for further welding or fabrication of the work piece.

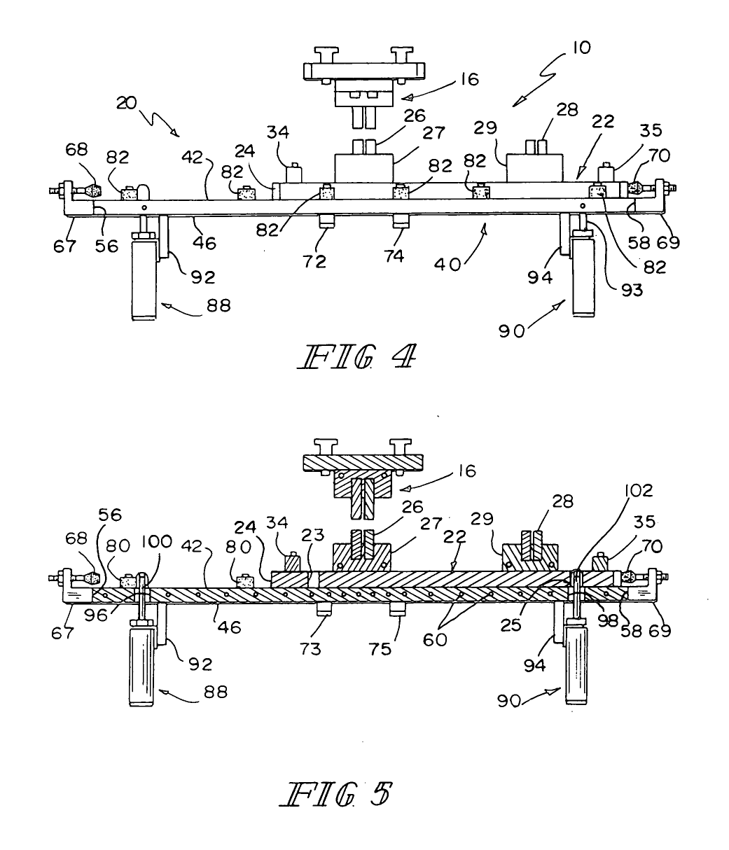

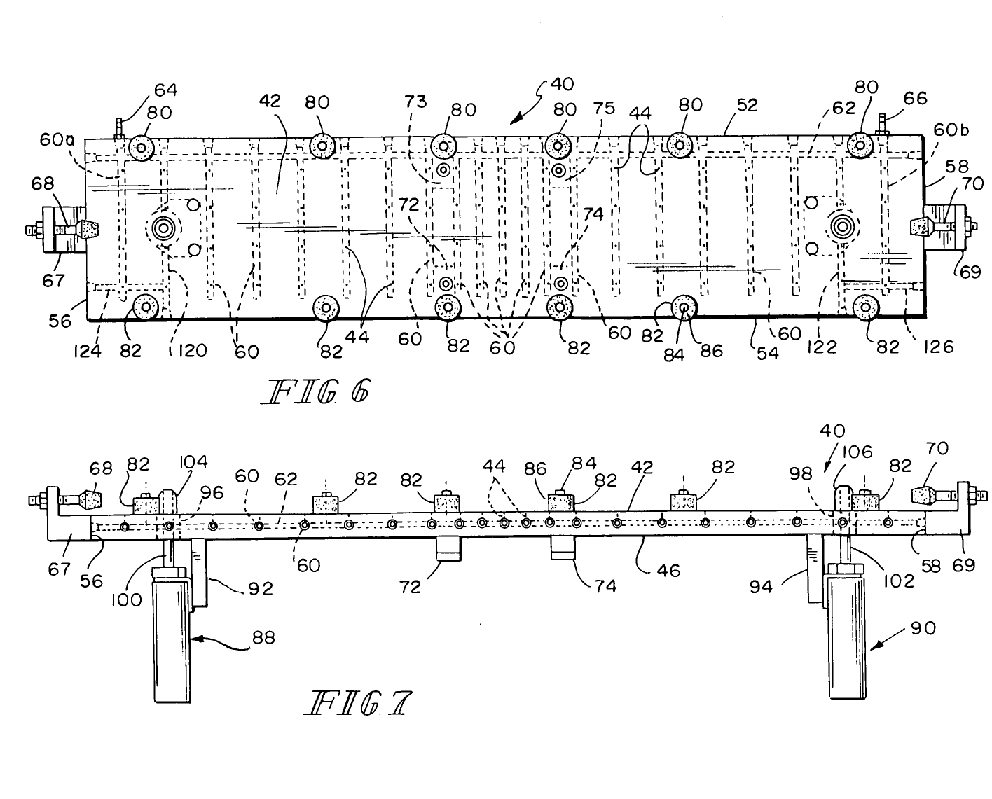

Referring to FIGS. 4 and 5, weld-through device 20 is shown with work piece support 30 removed from base 24 and base 24 supported on support member 40 in the engaged position. Base 24 includes mounting members 34, 35 extending from an upper side thereof for engagement with work piece support 30. Electrodes 26, 28 extend from stanchions 27, 29, respectively, which extend from base 24. Stanchions 27, 29 can be comprised of the same electrically conductive material as base 24 while mounting members 34, 35 may be comprised of different, non-conductive material. Base 22 can further include through holes 23, 25 adjacent opposite ends thereof in communication with support surface 42.

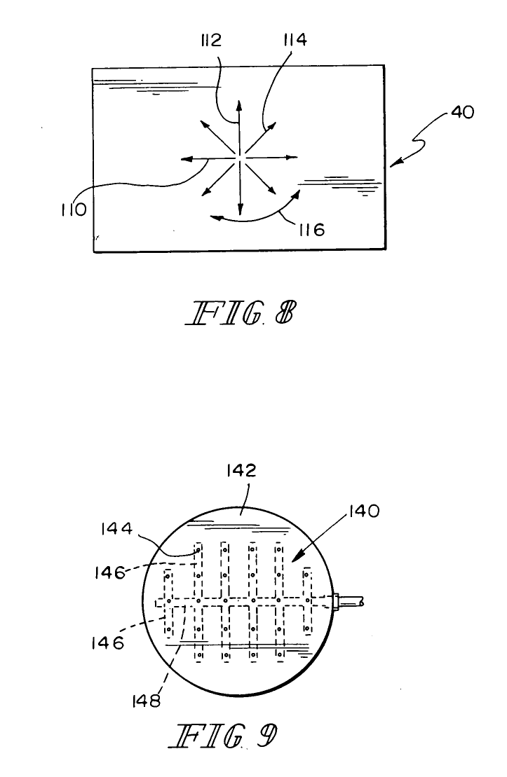

With further reference to FIGS. 6 and 7, support member 40 will be further discussed. Support member 40 includes support surface 42 and opposite bottom surface 46 extending between opposite sidewalls 52, 54 and opposite endwalls 56, 58. Holes 44 open along support surface 42. In the illustrated embodiment, holes 44 are arranged linearly in rows extending between sidewalls 52, 54. The holes 44 in a particular row are connected with one another within the row with a respective one of the connection passages 60, it being understood that only a selected few of the substantially identical connection passages 60 are identified with lead lines for clarity. The connection passages 60 are connected with one another at an end thereof along sidewall 52 with a distribution passage 62 that extends between endwalls 56, 58. While only one distribution passage 62 is shown, it is also contemplated that two or more distribution passages may be provided between connection passages. In still other embodiments, no distribution passage is provided, and the connection passages are each coupled to the fluid supply.

In the illustrated embodiment, connection passages 60 include a blind end adjacent sidewall 54 and include an opposite end plugged along the other sidewall 52. The plugs can be removable to facilitate cleaning and inspection of connection passages 60. Furthermore, inlets 64, 66 are provided at respective ones of the end connection passages 60a, 60b for connection with the fluid supply. Inlets could also be provided for one or more of the other connection passages 60. Distribution passage 62 includes opposite end openings in endwalls 56, 58 that are also plugged, but are also accessible for cleaning and inspection. One or more inlets could also or alternatively be provided directly into distribution passage 62 for coupling with the fluid supply.

In the illustrated embodiment, connection passages 60 are spaced evenly from one another at the ends of support member 40 adjacent endwalls 56, 58. The connection passages 60 along the middle portion of support member 40 are spaced more closely to one another to provide a greater density of holes 44 at the middle of support member 40. The variable spacing of connection passages 60 and additional holes 44 toward the center of support member 40 provides greater load lifting capability where loading from tooling 22 is likely to be the greatest. In addition, the illustrated embodiment provides four holes 44 evenly spaced along each of the connection passages 60. Other embodiments contemplate that more or fewer holes can be provided along the respective connection passages 60. Furthermore, the number of holes 44 and/or the spacing between holes 44 can vary from one connection passage 60 to the other. It is also contemplated that the spacing of the portion of holes along a particular connection passage 60 can be varied.

Support member 40 includes a number of roller guides 80 positioned along sidewall 52 and a number of roller guides 82 along sidewall 54. Roller guides 80, 82 can rotate about their receptacle centers and relative to support member 40 as tooling 22 is moved therealong to maintain tooling 22 in alignment relative to support member 40 while not inhibiting movement in the direction between endwalls 56, 58. As shown with a typical roller guide 80, 82 in the figures, each of the roller guides 80, 82 can include a central mounting bolt 84 and a wheel 86 about bolt 84 that is rotatable relative to bolt 84 and support member 40. Other embodiments contemplate other guide structures along sidewalls 52, 54, including rails, posts, and other structures. Still other embodiments contemplate that roller guides are not provided, and side-to-side movement of tooling 22 is limited by any suitable structure or control device that is not mounted to support member 40.

Endwalls 56, 58 include mounting brackets 67, 69 mounted thereto. Mounting brackets 67, 69 each include a spindle 68, 70 extending therefrom toward the center of support member 40. Spindles 68, 70 are adjustable in brackets 67, 69 and relative to endwalls 56, 58 to provide an adjustable stop to limit movement of tooling 22 relative to support member 40 in the direction between endwalls 56, 58. Other embodiments contemplate support members with other structures to limit movement between endwalls 56, 58, including rails, posts, and other devices. Still other embodiments contemplate a support member without structure to limit movement between endwalls 56, 58, and that movement of the tooling between endwalls 56, 58 is controlled with any suitable structure or control device that is not mounted to support member 40.

Support member 40 further includes support brackets 72, 73, 74, 75 projecting from bottom surface 46. Support brackets 72, 73, 74, 75 can be mounted to frame 12 with any suitable fastener to secure support member 40 in welding system 10. Other embodiments contemplate any suitable structure for mounting support member 40 with the welding system.

Support member 40 further includes in the illustrated embodiment shot pin cylinders 88, 90 mounted to support member 40 with a respective one of the mounting bracket 92, 94 secured to support member 40 below bottom surface 46. Shot pin cylinders 88, 90 each includes a pin 100, 102 positionable through the respective aligned holes 96, 98 through support member 40. A cylinder 104, 106 is positioned about respective ones of the pins 100, 102 and is positionable in a respective one of the holes 23, 25 of base 24 when aligned therewith, such as shown in FIG. 5.

Support member 40 includes shot pin connection passages 120, 122 adjacent respective ones of the end connection passages 60a, 60b extending between sidewalls 52, 54. Linking passage 124, 126 are provided from the respective adjacent endwall 56, 58 through the respective end connection passage 60a, 60b to the connection passage 120, 122. Shot pin connection passages 120, 122 deliver fluid to the respective shot pin cylinder 88, 90. The fluid lowers cylinders 104, 106 below support surface 42 so that they are removed from the holes 23 or 25 to allow tooling 22 to move along support member 40. When the desired movement of tooling 22 has been obtained, the fluid supply is turned off and cylinders 104, 106 are biased to normally project from support surface 42 to engage tooling 22 in an aligned hole, if any, thereof. With the corresponding cylinder or cylinders 104, 106 engaged to tooling 22, the position of tooling 22 on support member 40 can be maintained during the welding procedure.

Referring now to FIG. 8, there is shown a diagram of support member 40 and various possible movement patterns of the tooling relative to support surface 42 when the tooling is in the gaseous fluid supported position. Movement can be completed in an axial manner as indicated by axial arrows 110 and 112 to move the tooling and thus the work piece in an end-to-end and side-to-side relationship relative to support member 40. It is further contemplated that diagonal movement of the tooling and workpiece can be provided as indicated by arrows 114. In still other embodiments, movement of the tooling and workpiece in a rotary fashion as indicated by arrows 116 is contemplated. Arrangements are also contemplated where movement of the tooling can be conducted in any one or combination of the diagonal, axial and rotational directions. Movement of the workpiece and tooling can be conducted manually, or through a control mechanism engaged to the tooling that can be programmed to provide the desired movement along support surface 42 when in the gaseous fluid supported position. After the desired movement is obtained, the fluid supply is turned off or isolated from the holes 44, and the tooling re-engages the support surface by gravity and/or a mechanical assist device.

In the embodiments illustrated above, support member 40 includes a rectangular shape. Other embodiments contemplate that the support member can have other shapes. For example, FIG. 9 shows a support member 140 that includes a circular shape to provide a circular support surface 142. Support surface 142 includes a plurality of holes 144 interconnected with connection passages 146 and distribution passage 148. Still other embodiments contemplate arrangements where the support surface has a shape that differs from the shape of the support member around its perimeter. It is further contemplated that the support surface and/or support member can have a square, polygonal, oval, or non-circular shape.

While the invention has been illustrated and described in detail in the drawings and foregoing description, the same is to be considered illustrative and not restrictive in character, it being understood that only selected embodiments have been shown and described and that all changes, equivalents, and modifications that come within the scope of the inventions described herein or defined by the following claims are desired to be protected. Any experiments, experimental examples, or experimental results provided herein are intended to be illustrative of the present invention and should not be construed to limit or restrict the invention scope. Further, any theory, mechanism of operation, proof, or finding stated herein is meant to further enhance understanding of the present invention and is not intended to limit the present invention in any way to such theory, mechanism of operation, proof, or finding. In reading the claims, words such as “a”, “an”, “at least on”, and “at least a portion” are not intended to limit the claims to only one item unless specifically stated to the contrary. Further, when the language “at least a portion” and/or “a portion” is used, the claims may include a portion and/or the entire item unless specifically stated to the contrary.

What is claimed is:

1. A weld-through device for electrical welding systems, comprising:
a support member comprised of an electrically conductive material, said support member for supporting tooling relative to said support member in an engaged position with a support surface between said tooling and said support member including a plurality of holes opening at said support surface, said holes being interconnected to permit passage of substantially gaseous fluid therethrough from a fluid supply to support the tooling in a gaseous fluid supported position relative to said support member for movement of the tooling relative to said support member.

2. The device of claim 1, wherein said support surface is formed by said support member and includes a circular shape.

3. The device of claim 2, wherein said support member defines a number of connection passages each connecting a respective portion of said plurality of holes and a distribution passage connecting said connection passages.

4. The device of claim 1, wherein said support surface is flat.

5. The device of claim 1, wherein said support surface extends between opposite sidewalls and opposite endwalls of said support member.

6. The device of claim 5, further comprising roller guides along said sidewalls and stop members at said endwalls, said roller guides and said stop members being positioned adjacent said support surface.

7. The device of claim 5, wherein said support member defines a number of connection passages therein, each of said connection passages connecting a respective portion of said plurality of holes, wherein said connection passages are connected with the fluid supply.

8. The device of claim 7, wherein said support member defines at least one distribution passage interconnecting said connection passages.

9. The device of claim 8, wherein said distribution passage extends between said opposite endwalls adjacent one of said sidewalls and said connection passages extend from said one sidewall toward the other sidewall.

10. The device of claim 1, wherein said substantially gaseous fluid is air.

11. A weld-through device for electrical welding systems, comprising:
a support member comprised of electrically conductive material, said support member including a support surface;
tooling having a base comprised of electrically conductive material supported on said support surface of said support member in an engaged position to provide an electrical path through said support member; and
means for lifting said tooling from said engaged position to a spaced relationship with said support surface for re-positioning said tooling relative to said support surface in said spaced relationship.

12. The system of claim 11, wherein said means for supporting includes a plurality of holes in said support surface and a fluid supply connected with said holes operable to deliver a substantially gaseous fluid between said support surface and said base to support said base in said spaced relationship with said support surface.

13. The system of claim 12, wherein said support member includes a plurality of passages through said electrically conductive material interconnecting said plurality of holes.

14. The system of claim 12, wherein said substantially gaseous fluid is air.

15. The system of claim 12, wherein said base is sized relative to said support member to overlap a portion of said plurality of holes.

16. The system of claim 11, wherein said support member includes opposite sidewalls and opposite endwalls extending between said sidewalls, said endwalls each including a stop member projecting therefrom adjacent said support surface to limit movement of said tooling between said endwalls and said sidewalls include guide roller therealong to maintain said tooling between said sidewalls and facilitate movement of said support member along said support surface in said spaced relationship.

17. The system of claim 16, wherein said stop members each include a bracket mounted to said respective endwall and a spindle extending from said bracket toward said support member, said spindle being adjustable relative to said bracket to reposition an end of said spindle relative to said support surface.

18. The system of claim 16, wherein said guide rollers each including a mounting member secured to said support member and a wheel secured to said support member with said mounting member, said wheel being rotatable about mounting member and relative to said support member.

19. The system of claim 11, wherein said electrically conductive material is a copper alloy.

20. The system of claim 11, wherein said support surface includes a rectangular shape.

21. The system of claim 11, wherein said support surface includes a circular shape.

22. A method for welding a workpiece, comprising:
securing a workpiece to tooling engaged to a support member;
spacing the tooling from the support member along a support surface;
moving the tooling relative to the support member with the tooling spaced from the support member; and
re-engaging the tooling to the support member along the support surface to provide an electric current pathway between the tooling and the support member.

23. The method of claim 22, wherein spacing the tool includes lifting the tooling from the support member with substantially gaseous fluid between the tooling and the support member along the support surface.

24. The method of claim 23, wherein the support surface extends along the support member and the substantially gaseous fluid includes air delivered through a plurality of interconnected holes in the support surface of the support member.

25. The method of claim 23, wherein the support member includes the support surface and a plurality of interconnected holes extending through the support surface and moving the tooling includes moving the tooling along the support surface with gaseous fluid supplied through at least a portion of the plurality of interconnected holes in the support surface in overlapping arrangement with a base of the tooling.

26. The method of claim 22, wherein re-engaging the tooling includes positioning an electrically conductive base of the tooling in contact with the support member and the electric current pathway extends through the base and the support member.

27. The method of claim 22, wherein moving the tooling includes guiding the tooling between rollers extending along the support member with the tooling spaced from the support member.

28. The method of claim 22, wherein the tooling and the support member are each comprised of copper alloy material that are in contact when the tooling is re-engaged.

29. The method of claim 22, further comprising securing the tooling to the support member after re-engaging the tooling to the support member with a cylinder extending from the support member into a hole in the tooling.

30. The method of claim 29, further comprising retracting the cylinder into the support member simultaneously with spacing the tooling and before moving the tooling.
